(19) United States
(12) Patent Application Publication
(10) Pub. No.: US 2015/0137021 A1
(43) Pub. Date: May 21, 2015

(54) Replacement Valve Guide with Elastomeric Seal

(71) Applicant: Frank Ted Marishak, JR., Bedford, VA (US)

(72) Inventor: Frank Ted Marishak, JR., Bedford, VA (US)

(21) Appl. No.: 14/086,930

(22) Filed: Nov. 21, 2013

(51) Int. Cl. F16K 27/02

(52) U.S. Cl. CPC F16K 27/02
USPC 251/366

(57) ABSTRACT

An interference fit, replacement valve guide has a tubular body with one or more annular grooves formed circumferentially about an exterior surface. An elastomeric O-ring is contained within each annular groove. Each O-ring has an outer surface that extends beyond the outer surface of the valve guide. When the replacement valve guide is press fit into a cylinder head valve guide bore, the O-rings are compressed, forming a fluid tight seal between the valve guide bore's inner surface and the replacement valve guide's outer surface, thus preventing the contamination of engine cooling fluid with engine lubricating fluid, and vice-versa.

### CROSS REFERENCE TO RELATED APPLICATIONS

This application claims benefit to the filing date of a provisional application titled “Improved Replacement Valve Guides”, provisional application No. 61/796,908, filed Nov. 23, 2012.

### STATEMENT REGARDING FEDERALLY SPONSORED RESEARCH OR DEVELOPMENT

Not Applicable.

### BACKGROUND OF THE INVENTION

A valve guide is a necessary part of a reciprocating engine, for it locates a poppet valve stem within the cylinder head in alignment with the poppet valve seat. Valve guides wear out from the reciprocation of the valve stem, enlarging the valve guide's inside diameter, compromising their ability to locate the poppet valve's seat resulting in loss of compression and degraded engine performance. This problem is corrected by a process called a valve job, which consists of the removal of the existing valve guide and replacing the guide with a new valve guide, and re-cutting the poppet valve's seat off the center line of the newly installed valve guide.

Worldwide, there is an industry that specializes in rebuilding and remanufacture of internal combustion engines, bringing used and worn-out engines back to original manufacturer's specifications for tolerances and performance. The present invention pertains to the rebuilding of the cylinder head, and is an improvement to the interference fit, replacement valve guide. Interference fit replacement valve guides are tubular in design, with an inside diameter to accommodate a poppet valve stem, and an outside diameter slightly larger than the cylinder head's guide bore. The tubular valve guide is press fit into the guide bore, providing retention of the valve guide within the bore, and providing a fluid tight seal between interior regions of the cylinder head. The cylinder head valve guide bore is machined into the original cylinder head to accept the replacement valve guides.

Some cylinder head guide bores are machined through the cooling water jacket allowing the valve guide to contact the coolant. These types of valve guides are generally referred to as wet valve guides. This type of valve guide has less retaining surface area due to the coolant contact area, allowing only a press fit on either side of the coolant jacket. With interference or press fit valve guides, this reduced retention and sealing area can often leak between the guide bore and the valve guides outside diameter, causing loss of coolant and contamination of the lubrication system. Engine rebuilders recognize this problem, and after valve guide replacement, pressure test all wet guides for leaks. Some valve guide manufacturers recommend pressure testing after installation of the new guides. When a leaking valve guide is detected through pressure testing, the guide is removed and coated with a liquid sealant, allowed time for the sealant to cure, replaced within the guide bore, and again tested for leaks. This is a time consuming and expensive procedure. The present invention aims to overcome the deficiencies of interference fit replacement valve guides, which will decrease the time and cost involved in engine rebuilding and remanufacture. The present invention not only reduces time and costs in the remanufacture process, but will prevent future leaks in a wet valve guide, reducing the frequency of repairs and replacements of valve guides resulting from the prior art type valve guides.

Several attempts have been made through time to improve on the interference fit replacement valve guide, some of which are described as follows:

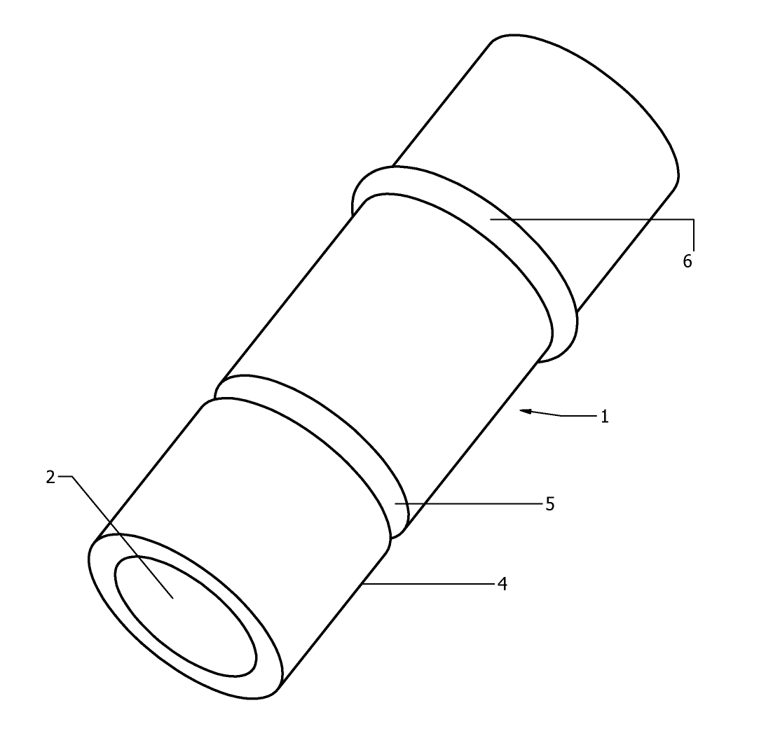

U.S. Pat. No. 2,222,457 to Sheibe shows in FIG. 3 a replaceable valve guide, which is retained in the cylinder head by a valve spring within the cylinder head's valve guide bore.

U.S. Pat. No. 3,345,976 to Pope shows annular seals placed on a valve guide for the purpose of introducing pressurized fluid to the poppet valve stem, but does not address the problem of sealing a damaged cylinder head valve guide bore.

U.S. Pat. No. 4,440,117 to Buchmuller shows valve guide sleeves not retained by interference fit, but by a retaining block.

U.S. Pat. No. 2,112,832 to Douglas shows a two piece valve guide which is not an interference fit within the valve guide bore.

While attempts have been made to improve upon the interference fit valve guide, none of the above patents solves the fluid sealing problems associated with the interference fit valve guides, which the present invention accomplishes.

### BRIEF SUMMARY OF THE INVENTION

The present invention provides an interference fit replacement valve guide which provides excellent retention within the cylinder head, and provides a leak tight seal, even in damaged valve guide bores. The present invention solves this retention and leakage problem by providing a tubular, press fit, valve guide having one or more annular channels which accept seals in the form of O-rings within the channels. When the valve guide is press fit into the cylinder head valve guide bore, the O-rings provide a fluid tight seal between the interior coolant fluid and the exterior lubrication system of the engine. A fluid tight seal is maintained even in engines whose valve guide bore may have been damaged by previous removals and insertions of replacement valve guides, or by distortion of the valve guide bores by engine overheating. The annular sealing O-rings are made of an elastomeric material which compresses and expands to continually provide a fluid tight seal between an imperfect valve guide bore and the replacement valve guide.

It is an object of the present invention to provide an improved interference fit replacement valve guide for internal combustion engines. Another object of the present invention is to provide a replacement valve guide which overcomes the deficiencies of prior art replacement valve guides. It is a further object of the present invention to provide a replacement valve guide with elastomeric seals that prevent fluid leakage between the cooling fluid region and the lubricating fluid region within the cylinder head. It is another object of the present invention to provide a replacement valve guide which will prevent leaks around the valve guide even in a damaged or disfigured valve guide bore.

These and other objects will become apparent with reference to the drawing figure and detailed description which follows.

### BRIEF DESCRIPTION OF THE DRAWING

The drawing figure shows a perspective view of the interference fit replacement valve guide of the present invention.

### DETAILED DESCRIPTION OF THE INVENTION

During the process of a valve job, damage to the cylinder head valve guide bore, which accepts the new replacement valve guide, can cause a leakage of coolant or lubricating fluid between the replaced valve guide and the damaged cylinder head valve guide bore. This damage occurs through improper removal of the originally installed valve guide, or in the installation of the newly replaced valve guide. Also, metal to metal galling and overheating causes warpage to a cylinder head and effects concentricity of the cylinder head's valve guide bores. These factors contribute to the aforementioned leaks of coolant, lubrication, or both, into the combustion chamber of the internal combustion engine.

An improved valve guide is described with reference to the drawing figure, which overcomes the before describe shortcomings of current, interference fit, replacement valve guides.

In the drawing, a replacement valve guide 1 is shown. Replacement valve guide 1 has a tubular shaped body with an inner bore 2 which accepts a poppet valve stem Inner bore 2 has an inner bore diameter which is substantially the same as the outer diameter of a poppet valve stem which reciprocates therein. Replacement valve guide 1 has an external diameter which is fractionally larger than the valve guide bore (not shown) into which replacement valve guide 1 is inserted, within the cylinder head of an internal combustion engine (also not shown). The slightly larger diameter of replacement valve guide 1 as compared to the internal diameter of the valve guide bore insures that the replacement valve guide forms an interference press fit when pressed into the valve guide bore. The replacement valve guide will theoretically not come loose from the valve guide bore, and will not develop fluid leaks between the valve guide bore inner surface and the exterior surface 4 of replacement valve guide 1.

However, in practice, this is not the case. Due to guide bore damage from removing and replacing valve guides, and from distortions of the valve guide from overheating, leaks will occur between the valve guide bore inner surface and the exterior surface 4 of replacement valve guide 1, necessitating replacement of the valve guide body.

Therefore, to prevent such leaks, replacement valve guide 1 is formed with one or more annular channels 5, circumferentially formed about exterior surface 4 of replacement valve guide 1. Within annular channels 5 are placed elastomeric O-rings 6. Outer surfaces of O-rings 6 extend beyond outer surface 4, such that when replacement valve guide 1 is press fit into a cylinder head valve guide bore, the elastomeric O-rings 6 are compressed to form a fluid tight seal between outer surface 4 of the valve guide and the inner surface of the valve guide bore.

Depending on the application, one or more annular channels 5 will be formed into the outer surface 4 of replacement valve guide 1. Each annular channel 5 will have placed therein an elastomeric O-ring 6. Typically, there will be at least one annular channel 5/O-ring 6 combination for each surface within the cylinder head valve guide bore needing to be sealed.

With the replacement valve guide 1 in place in a cylinder head valve guide bore, leakage of fluid between cooling fluid containing regions and lubricating fluid containing regions of the engine will be prevented. This leakage prevention will take place even though the valve guide bore may be scored or damaged from previous removal or replacement of press fit valve guides, or from valve guide bore distortion due to overheating of the cylinder head, due to the annular groove 5 containing elastomeric O-ring 6 sealing against the inner surface of the cylinder head valve guide bore.

While the invention has been described with respect to a specific drawing figure and embodiment, other embodiments can also be realized, and are within the scope of the present invention as claimed.

1. A replacement valve guide for placing into a valve guide bore within the cylinder head of an internal combustion engine comprising:
a tubular shaped body having an exterior surface and an internal bore;
an annular channel circumferentially formed about said exterior surface;
an elastomeric O-ring placed within said annular channel;
wherein said elastomeric O-ring prevents fluid leakage past said O-ring within the valve guide bore.

2. The replacement valve guide of claim 1, further comprising:
a second annular channel circumferentially formed about said exterior surface;
a second elastomeric O-ring placed within said second annular channel;
wherein said second elastomeric O-ring prevents fluid leakage past said second O-ring within the valve guide bore.

3. A replacement valve guide for placing into a valve guide bore within the cylinder head of an internal combustion engine comprising:
a tubular shaped body having an exterior surface;
multiple annular channels circumferentially formed about said exterior surface;
an elastomeric O-ring placed within each of said multiple annular channels;
wherein each of said elastomeric O-rings prevents fluid leakage past each said O-ring within the valve guide bore.
